(19) United States
(12) Patent Application Publication
(10) Pub. No.: US 2024/0367941 A1
(43) Pub. Date: Nov. 7, 2024

(54) ELEVATOR SAFETY DEVICE

(71) Applicant: Brian A. Schafer, Eagle, ID (US)

(72) Inventor: Brian A. Schafer, Eagle, ID (US)

(21) Appl. No.: 18/600,594

(22) Filed: Mar. 8, 2024

Related U.S. Application Data
(60) Provisional application No. 63/489,121, filed on Mar. 8, 2023.

(51) Int. Cl. B66B 5/00

(52) U.S. Cl. CPC B66B 5/0062

(57) ABSTRACT

A surface-mountable elevator motion detector includes a housing, removably mountable upon a surface of a movable element of an elevator system within an elevator hoistway, and a microcontroller circuit. The detector includes a motion sensor and an indicator device, coupled to the microcontroller circuit, configured to activate the indicator device upon motion of the movable element.

### PRIORITY CLAIM

The present application claims priority from U.S. Provisional Patent Application Ser. No. 63/489,121, filed on Mar. 8, 2023, and entitled Elevator Safety Device, the disclosure of which is incorporated by reference herein in its entirety.

### BACKGROUND

### Field of the Invention

The present application relates generally to elevator safety systems. More particularly, the present application relates to a portable, removably attachable device for alerting workers and other personnel in an elevator hoistway of the presence of a moving counterweight or elevator.

### Related Art

Elevators typically use a cab enclosure to lift occupants and/or cargo within a vertical shaft of a building. The shaft in which the cab enclosure travels is also called a “hoistway”. The elevator cab enclosure travels vertically in the hoistway between landings at different floor levels of the building. Each landing has a door or doors that open and close in conjunction with the elevator door(s) to allow ingress and egress into the elevator cab enclosure, as well as allowing access to the hoistway.

To maintain, service, or repair an elevator or its components, an elevator technician can enter an elevator hoistway, placing the technician in close proximity to the elevator cab, counterweights and other components of the system. For example, an elevator technician may work atop an elevator cab, using the top of the cab as a work platform to access overhead components of the system. Alternatively, the technician may work in the elevator “pit”, that is, the bottommost region of the hoistway, below the elevator cab. In these or other such circumstances, the technician normally disables motion of the elevator components as a safety precaution, but it is still possible that circumstances can arise where the cab enclosure or counterweight might move while the maintenance worker is in the hoistway. Such situations can present significant safety hazards which, if not properly recognized by the worker, can potentially lead to serious injury.

Several systems have been developed that attempt to provide safety to elevator maintenance workers within a hoistway. However, many of these utilize fixed or integrated alarms and/or sensors, and can be difficult to install in a pre-existing elevator system. Further, many of these systems rely on communication between multiple devices and utilize fixed or integrated alarms and/or sensors that are built into an existing elevator to alert the technician that the enclosed cab or other components of the elevator system, are moving. Such systems often are not portable between elevator systems and are typically installed in new installations and with new products.

### SUMMARY

It has been recognized that it would be advantageous to develop a portable, handheld device that is easy for a worker to place on a movable portion of an elevator system, which will detect movement without the need for separate sensors installed in the hoistway, or on the elevator components.

It has also been recognized that it would be advantageous to have an elevator motion detection device that is not dependent upon fixed or integrated alarms and/or sensors.

It has also been recognized that it would be advantageous to have an elevator motion detection device that is easy to install in a pre-existing elevator system, does not rely on communication between multiple devices, and does not rely upon fixed or integrated alarms and/or sensors that are built into an existing elevator.

In accordance with one embodiment thereof, the present disclosure provides an elevator safety device having a housing, removably mountable upon a movable element of an elevator system within an elevator hoistway, having a power source and a microcontroller disposed within the housing. The microcontroller circuitry is operatively coupled to the power source, a motion sensor, and at least one indicator device. The indicator device is configured to provide a cognizable indication when the motion sensor indicates motion of the movable element.

In accordance with another aspect thereof, the disclosure provides an elevator safety device having a housing, with a magnetic mount, disposed upon the housing, configured for removably mounting the housing upon a movable element of an elevator system. The device further includes a microcontroller, comprising circuitry including a motion sensor, and an indicator device, configured to provide a cognizable indication when the motion sensor detects motion of the movable element.

In accordance with yet another aspect thereof, the disclosure provides a surface-mountable elevator motion detector, including a housing, removably mountable upon a surface of a movable element of an elevator system within an elevator hoistway, and a microcontroller circuit, disposed within the housing. The detector includes a motion sensor and an indicator device, configured to activate the indicator device upon motion of the movable element.

### BRIEF DESCRIPTION OF THE DRAWINGS

Additional features and advantages of the disclosure will be apparent from the detailed description which follows, taken in conjunction with the accompanying drawings, which together illustrate, by way of example, features of the disclosure, and wherein:

FIG. 1 is a top perspective view of an embodiment of an elevator safety device in accordance with the present disclosure;

FIG. 2 is an exploded view of the elevator safety device of FIG. 1;

FIG. 3 is a cross-sectional view of a portion of a building having an elevator and related components in an elevator hoistway;

FIG. 4 is a perspective view of an elevator counterweight in an elevator hoistway, showing various placement alternatives for an elevator safety device in accordance with the present disclosure;

FIG. 5 is a top view of the elevator safety device of FIG. 1;

FIG. 6 is a bottom view of the elevator safety device of FIG. 1;

FIG. 7 is a side view of the elevator safety device of FIG. 1;

FIG. 8 is a side cross-sectional view of and embodiment of an elevator safety device like that of FIG. 1;

FIG. 9 is a top view of an embodiment of a circuit board including the control circuitry of an embodiment of an elevator safety device in accordance with the present disclosure; and

FIG. 10 is a block diagram illustrating the functional components of an embodiment of an elevator safety device in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the disclosure is thereby intended. Alterations and further modifications of the features illustrated herein, and additional applications of the principles of the disclosure as illustrated herein, which would occur to one skilled in the relevant art and having possession of this disclosure, are to be considered within the scope of this disclosure.

As noted above, when an elevator technician works within an elevator hoistway, it is possible that the cab enclosure or counterweight can move while the maintenance worker is in the hoistway, presenting the possibility of serious injury to the maintenance worker. Advantageously, the present disclosure presents an integrated alarm and motion detector apparatus that is convenient for temporary worker installation on a movable component of an elevator system, providing a cognizable alert to the worker when motion is detected, thus allowing the worker to take immediate steps to avoid danger and injury.

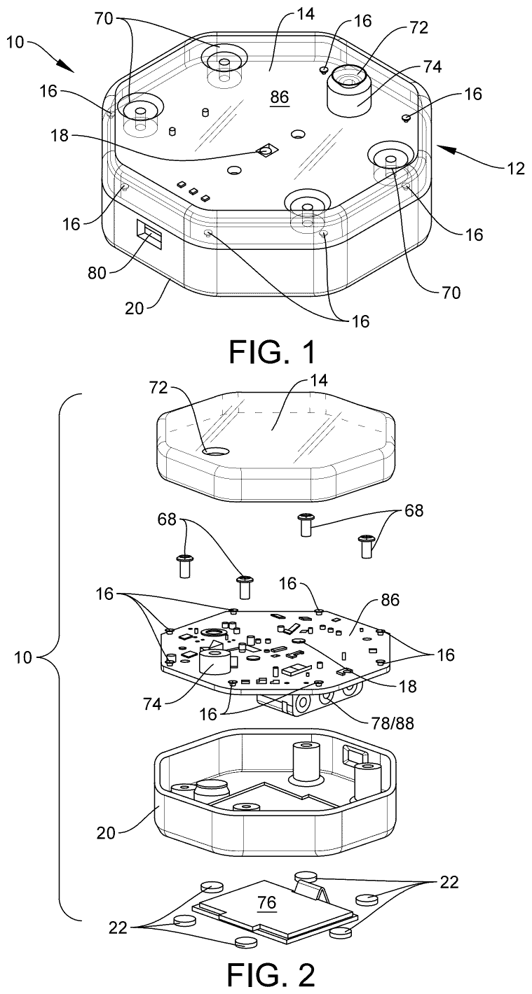

Shown in FIG. 1 is a top perspective view of an embodiment of a portable elevator safety device 10 in accordance with the present disclosure that can provide a cognizable alert to a worker when motion of an elevator component is detected. Provided in FIG. 2 is an exploded view of the elevator safety device 10 of FIG. 1. This elevator safety device 10 is relatively small and portable, having a size that is suitable for being manually handled by a worker and moved from place to place. The elevator safety device generally includes a housing 12, having an upper transparent or translucent portion 14 that allows the transmission of light from a plurality of lights or light emitting components 16, 18, such as LEDs. The lower portion 20 of the housing includes a releasable attachment device, such as a plurality of magnets 22 that are suitable for temporary/removable attachment of the device to a moveable component of the elevator system.

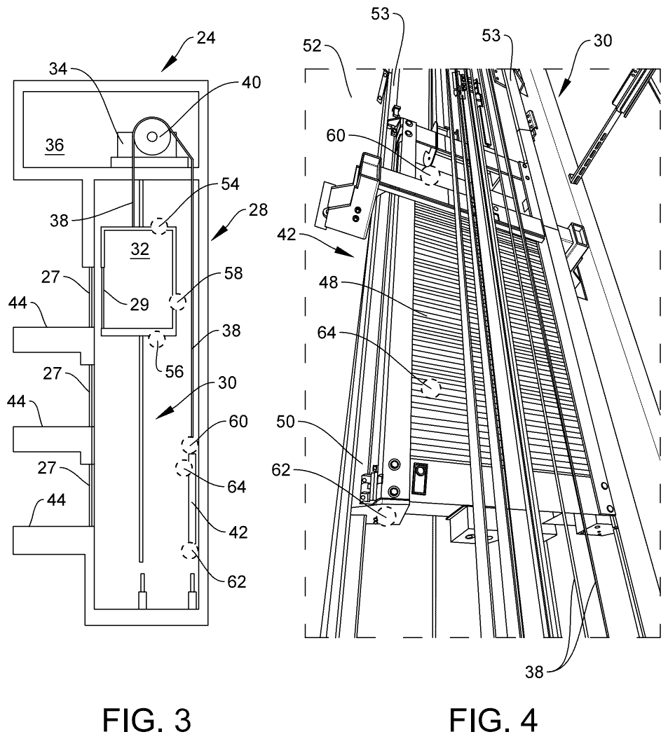

Shown in FIG. 3 is a cross-sectional view of a portion of a building 24 having a plurality of floors and an elevator system, indicated generally at 28, located in an elevator shaft or hoistway 30. Elevators generally utilize one of two types of mechanical systems to lift the cab enclosure. One system, called a geared or gearless traction system, utilizes a counterweight positioned in the shaft to balance the weight of the cab enclosure. An electric motor is used to hoist the cab enclosure up and down by a rope or cable. This is the type of elevator system 28 depicted in FIG. 3. A second type of elevator system is a hydraulic elevator, which utilizes a hydraulic piston/cylinder mechanism, driven by an electric motor, to lift and lower the cab enclosure.

The elevator system 28 generally includes a cab enclosure 32, attached to an electric traction motor 34 disposed in a mechanical room 36 above the hoistway via a group of cables 38. The cables 38 extend from the elevator cab 32 upward to and around a drive wheel or drum 40 associated with the traction motor 34, and then extend downwardly from the drive motor 34 to a counterweight 42 positioned in the shaft 30. The counterweight 42 balances the weight of the cab enclosure 32 when empty, so that the traction motor 34 need only provide sufficient lifting force to accommodate the actual load or contents of the elevator cab 32. It is to be understood that while the elevator system 28 shown in FIG. 3 is a cable-based traction hoist elevator system, the elevator safety device 10 disclosed herein can also be used with hydraulic elevator systems that employ a hydraulic piston/cylinder mechanism to lift and lower the cab enclosure 32.

The elevator system 28 vertically lifts occupants and/or cargo (not shown) contained in the elevator cab 32 within the shaft 30, allowing stoppage at landings 44 at each floor 26 of the building 24, where doors 27 at each landing 44 open and close in conjunction with the elevator door(s) 29 to allow access to and from the elevator cab 32. With the elevator cab 32 moved above or below any given landing 44, the doors at that landing can be opened by a technician or maintenance worker for access to the hoistway 30 at that particular level. The elevator technician can then work within the elevator hoistway 30, whether atop the elevator cab 32 or below it, within the pit 46, the bottommost region of the elevator shaft or hoistway 30.

Shown in FIG. 4 is a perspective view of an elevator counterweight assembly 42 of a traction hoist elevator system within an elevator hoistway 30. The counterweight assembly 42 generally includes a stack of heavy metal bars or weights 48, which are disposed within a narrow sliding frame 50 that is attached to one of the walls 52 of the hoistway 30, and connected to one or more hoist cables 38 of the traction hoist system. Other components that are common to elevator systems, such as counterweight guide rails 53 and other safety devices, are also shown in FIG. 4.

Advantageously, the elevator safety device 10 can be used in many different ways within the hoistway 30 to provide greater safety to a technician. The views of FIGS. 3 and 4 show various placement alternatives for the elevator safety device within the hoistway 30. As shown in FIG. 3, the elevator safety device 10 can be placed on the top of the elevator cab 32, as indicated at 54, on the underside of the cab, as shown at 56, or on a side wall of the cab, as indicated at 58. Other placement positions are also possible. For example, as shown in FIGS. 3 and 4, the device 10 can be attached to the top of the counterweight assembly 42 (either on the counterweights 48 themselves or to framework surrounding or attached to them) as shown at 60.

Alternatively, the device 10 can be attached to the undersurface of the counterweight stack 42, as shown at 62, or to a front or side portion of the counterweight assembly, as shown at 64. It is to be understood that the various possible placement locations for an elevator safety device 10 that are shown in FIGS. 3 and 4 are represented only symbolically. That is, a small octagonal icon is shown at various locations to merely indicate a possible placement location for the device 10, and is not intended to be a pictorial representation of the device among the components of the elevator system 28, or to represent the actual size of the device 10 at scale. It will also be apparent to those of skill in the art that many other placement options are also possible, depending upon the specific configuration of the elevator system 28 and the clearances between mechanical elements within the elevator hoistway 30. In general, any placement location that allows the elevator safety device 10 to move concurrently with other moving portions of the elevator system can be suitable.

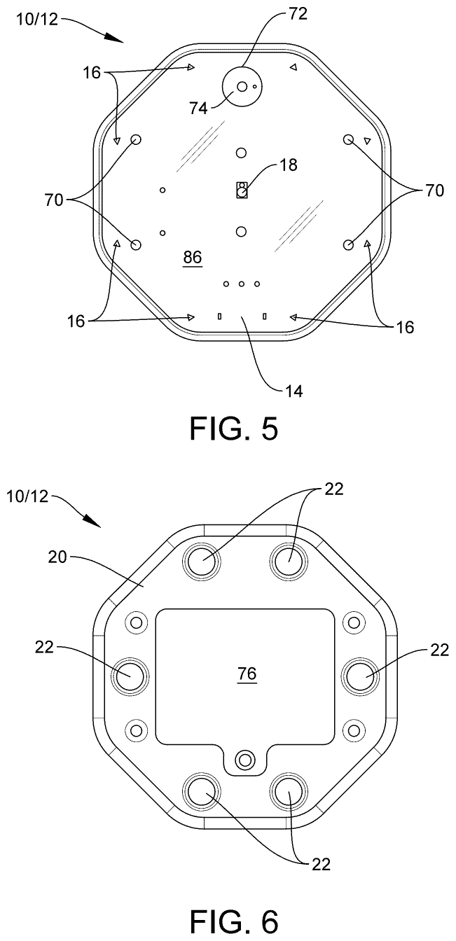

Various features and components of the elevator safety device 10 are more particularly shown FIGS. 1-2 and 5-9. Referring specifically to FIGS. 1-2 and 5, the elevator safety device 10 disclosed herein generally includes a housing 12, having a transparent or translucent upper portion 14, attached to a lower portion 20 (and some of the internal components thereof) by a plurality of screws 68 that extend through cylindrical recesses 70 in the upper portion 14. In the embodiment depicted in the figures, the housing 12 is of a regular octagonal shape, but it can be any other desired shape. In one embodiment, the elevator safety device is about 3½ inches across and about 1 inch thick overall. This general size is believed to be very practical because it is easy to use, relatively easy to transport, store and carry, and easy to attach to an elevator structure in locations where space may be limited. It is also easy to hold in the hand, and allows the device to easily utilize common AA or AAA batteries, for example. It will be apparent, however, that this is only one of many possible sizes, and an elevator safety device in accordance with the present disclosure can be configured in a wide variety of sizes. For example it is believed that an elevator safety device of this type that is less than about half the overall dimensions indicated above can be suitable, and one that is twice or more of the size indicated above can also be used. An overall size range of from about 2″ across to 8″ across is believed to be practical for a wide range of applications.

The transparent upper housing 14 exposes the printed circuit board (PCB) 86, on which various functional components of the device 10 are disposed, and allows easy viewing of the light emitting elements 16 (e.g. LED's) that are disposed around the perimeter of the PCB 86 within the upper housing 14. A centrally-located indicator light 18 is located in the center of the PCB 86, where it can be viewed through the upper portion 14 of the housing, to indicate to a user that the device is activated. The upper housing 14 can also include a speaker opening or recess 72, which allows sound from a speaker 74 to emanate from the device 10. The device 10 can also include a belt clip or other structure (not shown) on the outside of the housing 12, to allow a worker to attach the device to a tool belt or the like when the device is not in use, and/or for transporting the device.

With reference to FIG. 6, the lower housing portion 20 includes a group of magnets 22 that allow the device 10 to be attached to structure that is associated with a movable part of the elevator system 28. Specifically, in the embodiment that is shown, six disc magnets 22 are positioned in a spaced apart orientation and configured for attaching the housing 12 to any ferromagnetic part of the elevator cab 32 or counterweight 42. While multiple magnets 22 are shown in the depicted embodiment, a single magnet could also be used. In operation, after a worker accesses the hoistway 30, the worker attaches the device 10 to the cab enclosure 32 or counterweight 42 via the magnet(s) before commencing work, and removes it before exiting the hoistway 30 when the work is completed. Advantageously, for additional safety and peace of mind, multiple separate motion sensing devices 10 of this type can be used simultaneously, such as a separate device for each of the counterweight 42 and the cab enclosure 32.

It is to be understood that the magnets 22 shown in FIGS. 2, 6 and 8 are only one type of temporary/removable attachment system that can be used with the elevator safety device 10 disclosed herein. Other removable attachment devices can also be used for temporarily attaching the device to a moveable portion of an elevator system 28, such as clamps, hooks, quick-release bolts, etc. The lower housing portion 20 can also include an access door 76, which can allow access to a power supply 78 of the elevator safety device 10 and/or to other internal components of the device.

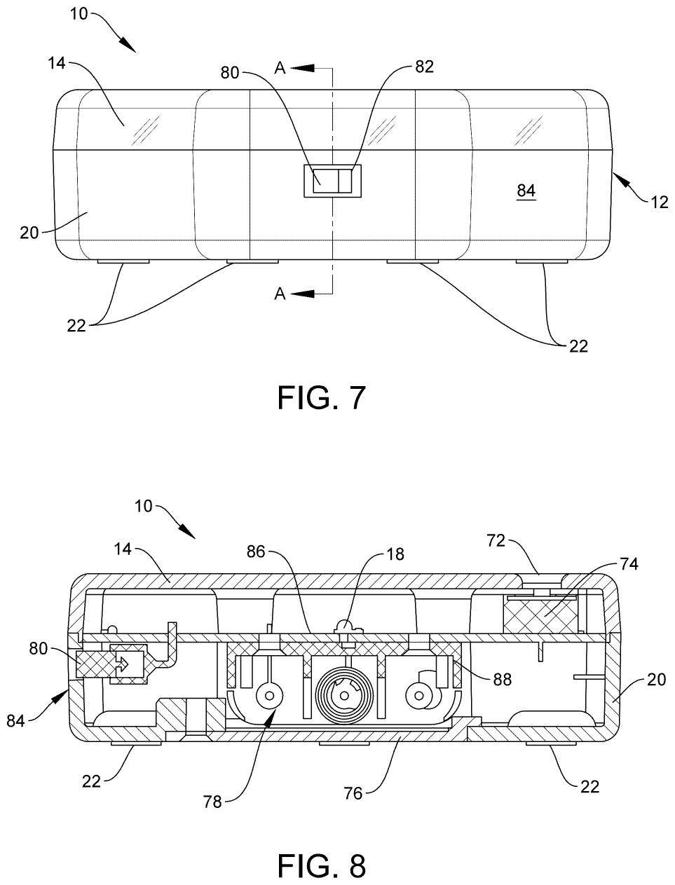

As shown in FIG. 7, an on/off activation switch 80 can be provided for activating the device. In the embodiment shown, this is a slide switch that is positioned within a recess 82 in the side wall 84 of the lower housing 20, in order to help prevent inadvertent activation or deactivation of the device 10. When this device 10 is activated using the switch 80, the central indicator light 18 illuminates to confirm to a user that the device 10 is in operation. It will be apparent that the activation switch 80 can be configured in other ways and located in other locations. Alternatively, or in addition to the activation switch 80, the device can include a contact switch or other similar device that automatically actuates the device 10 when it is attached to an elevator cab or other elevator structure.

Viewing the exploded view of FIG. 2 and the side cross-sectional view of FIG. 8, many of the internal components of the elevator safety device 10 are shown in more detail. The cross-sectional view of FIG. 8 is taken along section line A-A in FIG. 7. Centrally disposed within the housing 12 between the top housing 14 and lower housing 20, in a generally horizontal orientation, is a printed circuit board (PCB) 86, which includes most of the functional and operational components of the elevator safety device 10. In the embodiment shown in FIG. 8, the power supply 78 comprises a battery housing 88 that is attached to the bottom side of the circuit board 86, adjacent to the access door 76 in the bottom housing portion 20. The battery housing 88 shown in FIG. 8 is configured for containing a plurality of replaceable dry cell batteries (e.g. AA or AAA cells), but, as discussed in more detail below, the power supply 78 for the circuitry of the device 10 can be configured in this or a variety of other ways. In the view of FIG. 8 the magnets 22 are also shown on the bottom of the lower housing 20.

Shown mounted atop the circuit board 86 in FIG. 8 are some of the LED light elements 16, the activation indicator lamp 18, and a speaker 74 disposed adjacent to the speaker opening 72 in the top housing 14. The activation switch 80 is also visible in the side wall 84 of the lower housing portion 14.

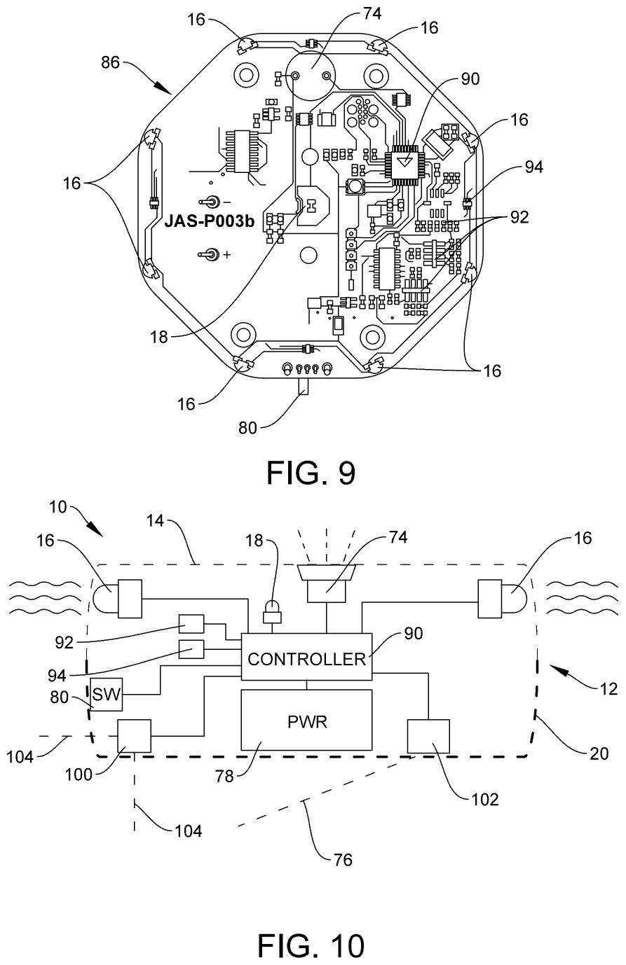

Additional details of the elements mounted on the PCB 86 are shown more clearly in FIG. 9, which provides a top view of the circuit board 86. It is to be understood that the circuit board 86 in the embodiment shown is octagonal in shape, in order to generally match the shape of the housing 12 of the device 10, but both the circuit board 86 and the device 10 can be any desired shape. Mounted on the circuit board 86 are a microcontroller chip 90, which is the primary processor for the device, one or more accelerometers 92, and an altimeter/pressure sensor 94, all of which are electrically interconnected to the controller chip 90. In the embodiment that is shown, the accelerometer(s) 92 and the altimeter/pressure sensor 94 are the primary motion sensing components of the elevator safety device 10. Also mounted on the circuit board 86 and functionally connected to the microcontroller 90 are a series or array of motion-indicating light emitting diodes (LEDs) 16, positioned around the perimeter of the circuit board 86, the speaker 74, and the central activation indicator lamp 18, which provides an indication when the activation switch 80 is moved to the “on” position.

The array of perimeter LEDs 16 are configured as the primary motion warning lights, and can be high intensity LEDs. In the embodiment shown, these LEDs 16 are referred to as side-emitting LEDs, oriented to emit light primarily through the sidewall 96 of the top portion 14 of the housing 12. The activation indicator lamp 18 can be an upwardly directed LED, and simply indicates to a user that the device is in operation. In the embodiment shown in these figures, the elevator safety device 10 thus includes a total of nine LEDs (16, 18), with eight providing side illumination (LEDs 16) and one providing illumination in the center of the device (LED 18). The LEDs can have any desired color. Because the device is a safety device, it can be desirable that the side-emitting motion warning LEDs 16 provide red light, while the actuation indicator lamp 18 can be a green LED.

As noted above, the circuit board 86 shown in FIG. 9 includes one or more accelerometers 92 for detecting motion of the device 10 (and thus of the elevator cab 32). The accelerometers 92 can be mems (micro-electro-mechanical) devices that are fabricated on a microprocessor chip. Alternatively, other types of small accelerometers that are commercially available can be used and coupled to the circuitry on the circuit board 86. It is considered possible that a single accelerometer 92 can be used if the elevator safety device 10 is to be used in one specific orientation relative to the direction of motion of the elevator in all instances of use. That is, a single axis accelerometer 92 can be sufficient if the device 10 is always positioned for use in an orientation in which the direction of motion of the elevator 32 corresponds to the axis of the accelerometer 92.

However, because such consistency of use can be difficult to ensure in all cases, it can be desirable to provide multiple accelerometers 92, oriented with their axes orthogonal to each other. In the embodiment shown in FIG. 9, three accelerometers 92 are provided for this purpose, so that the device 10 will be able to reliably detect motion regardless of the position or orientation of its placement on the elevator component. As another alternative, a single multi-axis accelerometer 92 can be used for the same purpose.

In the embodiment of FIG. 9, an altimeter 94 is also provided in combination with the accelerometers 92 for detecting motion of the elevator system 28. The altimeter 94 detects very small changes in air pressure, which are associated with vertical motion, and provides an additional sensor input to the microcontroller 90 for detecting motion. Other motion detecting devices can also be used in conjunction with the circuit shown in FIG. 9, as discussed below.

It can be desirable to have multiple sensors and/or types of sensors for detecting motion so that the microcontroller 90 can correct for detection errors, in order to avoid false alarms. Whichever type of motion sensor is used, when motion is detected the microcontroller 90 can cause the device 10 to emit a visual alarm via the array of side-emitting LEDs 16, and/or an audible alarm via the speaker 74. A visual alarm can be the LEDs 16 flashing in a strobe or flash pattern (e.g. red or white in color) upon detection of motion. The audible alarm provided via the speaker 74 can be a high-pitched or otherwise noticeable audible sound that alerts the user to the motion. The controller 90 of the device 10 can be configured to automatically stop the lights 16 and/or audible alarm via the speaker 74 when vertical movement of the elevator component stops. Alternatively, the device 10 can be configured so that after activation of a visual and/or audible alarm, the device 10 must be reset by the user turning it off and then on again via the switch 80. The microcontroller 90 can also be programmed so that the activation indicator light 18 can have different flash patterns to indicate modes of operation, such as ready, reset, error, etc., for the information of the user.

Provided in FIG. 10 is a block diagram illustrating the functional components of an embodiment of an elevator safety device 10 in accordance with the present disclosure. In this figure, the functional components are given the same reference numerals as for the physical components shown in the other figures and discussed above, to the extent possible. As shown, the device 10 generally includes a housing 12, which contains a power supply 78, a microcontroller 90, one or more sensing devices 92, 94, 100, and one or more output devices 16, 74. As discussed above, the power supply 78 can be configured in many ways, such as a battery holder (88 in FIG. 8) for holding dry cell batteries (e.g. replaceable AA or AAA batteries) or for holding a 9-Volt CR123A or other battery system. Advantageously, the power supply 78 is easily accessible through the access door 76 in the bottom of the housing 12. Alternatively, the power supply 78 can include an integral rechargeable battery, such as a lithium-ion battery, in which case the device can include a socket 102, such as a USB-C or other connection, for connection to an external power source, whereby the power supply can be recharged or the device coupled to an external source of electrical current.

As noted above, the sensing devices can include one or more of an accelerometer 92 and an altimeter 94. It is to be understood that the accelerometer 92 shown in FIG. 10 is intended to be indicative of any number of accelerometers having any combination of axes of detection, and/or a multi-axis accelerometer. Additional sensing devices can also be included. For example, a laser range finder 100 can also be used to detect motion. This range finder 100 can be coupled to the microcontroller 90 and provide one or more lasers 104 directed in a vertical and/or horizontal or other orientation. By means of the laser beam(s) 104, the laser range finder 100 can detect motion of the elevator component toward or away from the top or bottom of the hoistway 30, indicating vertical motion. Alternatively, the laser range finder 100 can be directed at a sidewall (e.g. sidewall 52 in FIG. 4) or other structure of the hoistway 30, and thereby detect the natural and inevitable distance variations between the surface of the elevator shaft walls and the elevator cab 32 or other elevator components when the elevator cab 32 or counterweights 42 move.

The output devices can include the speaker 74 for providing an audible alarm, and one or more light emitting devices, such as LEDs 16. Upon detection of motion, the microcontroller 90 can cause the speaker 74 to emit a loud audible alarm, while the light emitting devices 16 emit a strobe or flashing light signal. The microcontroller 90 can be a simple circuit that causes light activation and/or audible alarm when the sensing devices sense movement of the device. Alternatively, the controller 90 can be programmed to correct for possible mis-detection situations, such as may be indicative of mere vibration, wind, minimal motion, etc., so that false alarms are avoided. This can be accomplished by the use of both hardware and software associated with the controller 90 to compare signals from all of the sensor devices, and mathematically cancel out signal noise from the sensors, so that the device only detects vertical motion.

It is to be understood that the above-referenced arrangements are illustrative of the application of the principles of the present disclosure. It will be apparent to those of ordinary skill in the art that numerous modifications can be made without departing from the principles and concepts of the disclosure as set forth in the claims.

What is claimed is:

1. An elevator safety device, comprising:
a housing, removably mountable upon a movable element of an elevator system within an elevator hoistway;
a power source, disposed within the housing;
a microcontroller, disposed within the housing and coupled to the power source;
a motion sensor, operatively coupled to the microcontroller circuit; and
at least one indicator device, coupled to the microcontroller, configured to provide a cognizable indication when the motion sensor indicates motion of the movable element.

2. An elevator safety device in accordance with claim 1, wherein the motion sensor included one or more devices selected from the group consisting of an accelerometer, an altimeter and a laser range-finder.

3. An elevator safety device in accordance with claim 2, wherein the motion sensor is a micro-mems accelerometer device incorporated into the microcontroller circuit.

4. An elevator safety device in accordance with claim 2, wherein the accelerometer is a multi-axis accelerometer.

5. An elevator safety device in accordance with claim 1, wherein the indicator device is selected from the group consisting of a light emitter and a sound emitter.

6. An elevator safety device in accordance with claim 5, wherein the light emitter comprises one or more LEDs.

7. An elevator safety device in accordance with claim 6, further comprising a translucent cap, disposed upon the housing, the LEDs being disposed within the translucent cap.

8. An elevator safety device in accordance with claim 5, wherein the sound emitter comprises an audio speaker configured to provide an audible alarm.

9. An elevator safety device in accordance with claim 1, wherein the moveable element is one of an elevator cab and an elevator counterweight.

10. An elevator safety device in accordance with claim 1, wherein the housing is removably mountable upon the movable element via a magnetic mount, associated with the housing.

11. An elevator safety device, comprising:
a housing;
a magnetic mount, disposed upon the housing, configured for removably mounting the housing upon a movable element of an elevator system;
a microcontroller, comprising circuitry including a motion sensor; and
an indicator device, configured to provide a cognizable indication when the motion sensor detects motion of the movable element.

12. An elevator safety device in accordance with claim 11, wherein the motion sensor comprises at least one of an accelerometer, an altimeter and a laser range-finder.

13. An elevator safety device in accordance with claim 11, wherein the housing is about 3.5″ across and about 1″ thick.

14. An elevator safety device in accordance with claim 11, wherein the indicator device is selected from the group consisting of a light emitter and a sound emitter.

15. An elevator safety device in accordance with claim 11, further comprising:
a translucent cap, disposed in the housing; and
the indicator device comprising a light element, disposed beneath the translucent cap.

16. A surface-mountable elevator motion detector, comprising:
a housing, removably mountable upon a surface of a movable element of an elevator system within an elevator hoistway;
a microcontroller circuit, disposed within the housing, including a motion sensor and an indicator device, configured to activate the indicator device upon motion of the movable element.

17. A surface-mountable elevator motion detector in accordance with claim 16, wherein the indicator device is selected from the group consisting of an LED and a sound emitter.

18. A surface-mountable elevator motion detector in accordance with claim 17, wherein the indicator device comprises a plurality of LEDs, disposed adjacent to a translucent element of the housing.

19. A surface-mountable elevator motion detector in accordance with claim 16, wherein the motion sensor comprises at least two sensing elements selected from the group consisting of an accelerometer, an altimeter and a laser range-finder, and the microcontroller circuit is configured to compare signals from the at least two sensing elements to cancel signal noise therefrom, to prevent erroneous motion sensing events.

20. A surface-mountable elevator motion detector in accordance with claim 16, wherein the housing is removably mountable via a magnetic mount, disposed upon the housing.
